(19) United States
(12) Patent Application Publication
(10) Pub. No.: US 2015/0121846 A1
(43) Pub. Date: May 7, 2015

(54) SYSTEM FOR RECOVERING ENERGY FROM AN EXHAUST GAS CIRCUIT

(71) Applicant: Valeo Systemes de Controle Moteur, Cergy Saint Christophe (FR)

(72) Inventors: Grégory Hodebourg, Sartrouville (FR); Samuel Leroux, Poissy (FR)

(21) Appl. No.: 14/401,142

(22) PCT Filed: Apr. 26, 2013
(86) PCT No.: PCT/FR2013/050936

§ 371 Date: Nov. 14, 2014

(30) Foreign Application Priority Data
May 15, 2012 (FR) 1254429

(51) Int. Cl. F02B 47/10; F02M 25/07

(52) U.S. Cl. CPC F02B 47/10; F02M 25/077; F02M 25/0727
USPC 60/273; 60/320; 60/311; 60/278

(57) ABSTRACT

The invention relates to a system for recovering energy from an exhaust gas circuit (3) of a heat engine (1), including an exhaust gas by-pass pipe (12) that includes a heat exchanger with two compartments, and has a first manifold (14) leading into one compartment (16) and a second manifold (15) leading into the other compartment (17), said system comprising a first valve (18) installed in the exhaust circuit (3) and capable of controlling the flow of gases into each of said manifolds (14, 15), and a second valve (20) intended to control the flow of gases at the outlet of the heat exchanger (13). The main technical feature of a system for recovering energy according to the invention is that the first valve (18) can only be used in two positions, a first position wherein same seals the first manifold (14), and a second position wherein same seals the exhaust circuit (3) and only allows the exhaunt gases to flow into the first manifold (14).

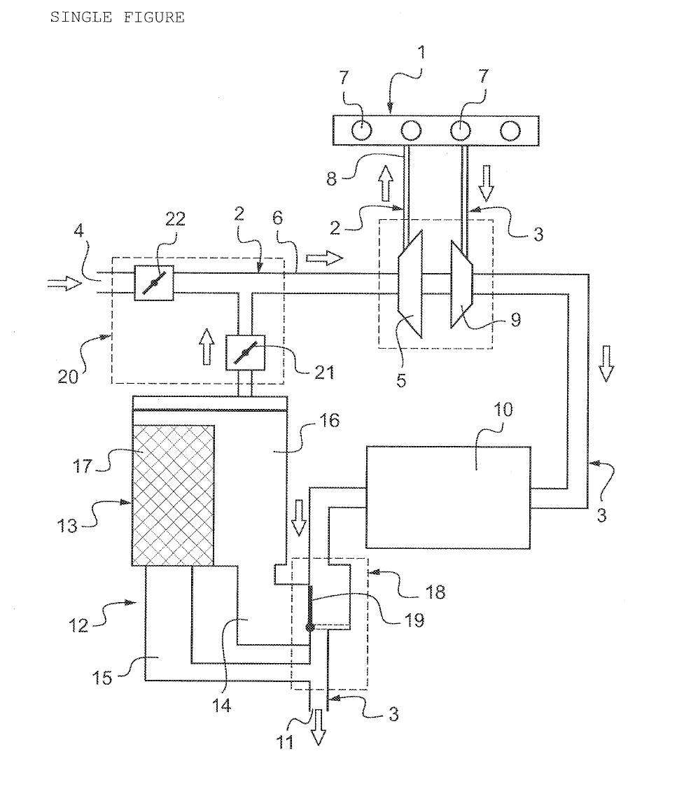

The invention relates to a system for recovering energy from an exhaust gas circuit. The context of the invention is motor vehicle heat engines, which generally need incoming gas to ensure, in each combustion chamber, together with the injected fuel, a satisfactory combustion, the exhaust gases from this combustion then being discharged into the atmosphere after having been depolluted. Now, it has been found that these exhaust gases which are raised to a certain temperature, rather than being discharged from the vehicle with no particular function, can be reused within said vehicle itself, in order, for example, to participate in the heating of the vehicle or to be rerouted to the incoming gases, in order to improve the combustion conditions in each of said chambers. The invention relates to an optimized energy recovery system, based on the use of these exhaust gases.

Energy recovery systems do exist and have already been the subject of patents. One patent that can for example be cited is FR2933746, which relates to a bypass pipe installed in the exhaust circuit, downstream of a recirculation system, said bypass pipe making it possible, either to route the exhaust gases into the air intake circuit, or to recover energy by heating a heat transfer fluid circulating in the heat exchanger. The exhaust gases are hot and can be rerouted as such into the intake circuit, or else be cooled by the exchanger beforehand, before reaching said intake circuit. These different configurations of use of this bypass are controlled by a first valve installed in the exhaust circuit, downstream of the recirculation system and upstream of the heat exchanger of said bypass pipe, and by a second valve situated downstream of said heat exchanger. This second valve comprises a shutter suitable for pivoting between an open position, for which it allows the exhaust gases from the heat exchanger to flow, to rejoin the intake circuit, and a closed position for which the exhaust gases are forced to circulate in the heat exchanger, before being discharged into the atmosphere through an outlet of the exhaust circuit. The bypass pipe comprises two inlet nozzles installed in parallel on the exhaust circuit, a first nozzle joining a first flow compartment of the exchanger, and a second nozzle joining a second compartment of the exchanger, in which a fluid circulates, that can for example be engine cooling water, said compartments being connected with one another. The first valve comprises a shutter mounted to pivot and suitable for occupying three distinct positions to reconstruct, in combination with the position of the shutter of the second valve, the three main configurations of use of this bypass pipe.
A first position of the shutter of the first valve corresponds to a blocking of the first nozzle. A portion of the exhaust gases then surges into the second nozzle to reach the second compartment of the heat exchanger where they are cooled. By opening the shutter of the second valve, the cooled exhaust gases, from the heat exchanger, will be routed to the intake circuit to be mixed with the incoming gases.
A second position of the shutter of the first valve corresponds to a blocking of the exhaust circuit, between the two nozzles, this second position being deduced from the first position by a rotation of said shutter through 90°. The hot exhaust gases all flow through the first nozzle to be reinstalled in the first compartment of the exchanger. By closing the shutter of the second valve, the hot exhaust gases will then pass to the second compartment and heat the fluid present in said second compartment, before flowing through the second nozzle then being discharged from the vehicle through an outlet of the exhaust circuit.
A third position of the shutter of the first valve corresponds to a blocking of the second nozzle, this third position being deduced from the second position by a rotation of said shutter through 90°, and being deduced from the first position by a rotation through 180°. A portion of the exhaust gases flows through the first nozzle and enters the first compartment of the exchanger. By opening the shutter of the second valve, the exhaust gases, which have not been cooled by the exchanger, will be routed to the intake circuit while hot, to be mixed with the incoming gases.

When the shutter of the second valve is in a closed position, the exhaust gases are forced to flow in a loop in the exchanger, entering through one nozzle, then flowing through the two compartments, before being discharged through the other nozzle to the exhaust circuit. If the shutter of the first valve blocks one of the two nozzles, the shutter of the second valve must necessarily be open, otherwise there will be a build-up of gas in the heat exchanger, with no possibility of it escaping.

The energy recovery system described in this patent, notably involving the two valves and the bypass pipe provided with a heat exchanger, makes it possible to use the bypass pipe, either for the recirculation of hot or cold exhaust gases, or for energy recovery. The energy recovery and gas recirculation functions are here completely dissociated, and can be provided only alternately. Now, it may be that, for certain phases of use of the engine, notably for cold starts, it is necessary to raise the engine temperature rapidly while ensuring good depollution of the gases.

An energy recovery system according to the invention makes it possible to address these two requirements, by coupling the energy recovery and hot exhaust gas recirculation functions. Thus, by way of example, a phase of recirculation of the hot exhaust gases in the intake circuit may be interspersed by a plurality of energy recovery phases over fairly short times, in order to perform recirculation of the gases and energy recovery almost simultaneously.

It is assumed known that an engine gas circulation comprises an upstream part forming the intake circuit, and a downstream part forming the exhaust circuit, the concepts of upstream and downstream having to be considered relative to the engine.

The subject of the invention is a system for recovering energy from a gas exhaust circuit of a heat engine, comprising an exhaust gas bypass pipe provided with a heat exchanger having a first flow compartment and a second compartment suitable for cooling the gases, said compartments being connected, said pipe having two inlet nozzles installed in parallel on the exhaust circuit, a first nozzle emerging in the first compartment and a second nozzle emerging in the second compartment, the first nozzle being installed on the exhaust circuit upstream of the second nozzle, said system comprising a first valve installed in the exhaust circuit and suitable for controlling the flow of the gases in each of said nozzles, and a second valve suitable for controlling the flow of the gases at the outlet of the heat exchanger, characterized in that the first valve has only two positions, a first position for which it blocks the first nozzle and allows the flow of the exhaust gases in the second nozzle and to the outlet of said circuit, and a second position for which it blocks the exhaust circuit between the points of connection of the two nozzles to said circuit and allows the flow of the exhaust gases only in the first nozzle. This first valve operates in a simplified manner compared to a valve of the prior art installed at the same point on the exhaust circuit and surrounded with the same elements. This is because it has only two operational configurations, whereas a prior-art valve offers a third configuration consisting in blocking the second nozzle. In combination with the second valve, this first valve makes it possible to obtain all the configurations of use of an existing energy recovery method involving a first valve with three positions, and which are: recirculation of hot exhaust gases to the intake circuit, recirculation of cooled exhaust gas to the intake circuit, and recovery of energy through the heating by the hot exhaust gases of a heat transfer fluid circulating in the heat exchanger and that can be, for example, engine cooling water. By passing through the heat exchanger only through the first compartment, the exhaust gases do not undergo any modification. If they are required to pass through the second compartment, they will then be brought into contact with a cold fluid, said gases will then have a tendency to be cooled in order to heat said fluid. The engine can be equipped with a compressor placed in the intake circuit, and a turbine placed in the exhaust circuit. It is assumed that the first and the second valves are controlled independently of one another.

Advantageously, the first valve has a shutter that can move in rotation, said shutter performing a rotation by a value of between 70° and 90° to switch from the first position to the second position. This is a well-controlled and accurate operating mechanism. The angles of 70° and 90° should be considered here from a theoretical point of view. In reality, there is a margin of uncertainty of approximately plus or minus 5° concerning the value of the angle.

Preferentially, the exhaust circuit has a gas recirculation system comprising a particulate filter, the first valve being installed in the exhaust circuit downstream of said recirculation system. In other words, the bypass pipe is installed at one end of the exhaust circuit, slightly set back from the outlet of said circuit to the open air. The exhaust gases required to pass through the heat exchanger will be clean, and there will therefore be no risk of fouling the heat exchanger, the second valve and, if appropriate, the intake circuit. Preferentially, the recirculation system may comprise a catalyst and an NOx trap.

Advantageously, the second valve is connected to the intake circuit, and is suitable for routing the exhaust gases from the heat exchanger into said intake circuit. In other words, this second valve comprises a point of connection with the intake circuit. Thus, when this valve is open, it contributes to ensuring a recirculation of the exhaust gases to the intake pipe.

Preferentially, the second valve comprises a shutter that can move in rotation and is suitable for pivoting between a closed position for which it blocks the gases in the exchanger, and an open position for which it allows the gases to flow to the intake circuit. The control of this valve is fundamental, because it will condition the mode of use of an energy recovery system according to the invention, either ensuring recirculation or performing energy recovery.

Advantageously, the shutter performs a rotation by a value of between 70° and 90° to switch from its open position to its closed position, said shutter being suitable for being fixed in at least one intermediate position situated between these two positions. In order to add a certain flexibility to the use of an energy recovery method according to the invention, the opening of the second valve is variable and makes it possible to accurately control the exhaust gas flow rate that it would be desirable to inject into the intake circuit, as a function notably of the phase of use of the engine.

Preferentially, the second valve comprises a second shutter controlling the flow rate of the gases into the intake circuit, upstream of the point of connection of said second valve to the intake circuit. For this configuration, the second valve can be likened to a choke. In addition to controlling the flow rate of the exhaust gases to be injected into the intake circuit, this second valve also manages the flow rate of the intake gases, very much upstream in said circuit, just after the air inlet of this circuit. This second valve thus ensures complete management of the flow rate and of the quality of the incoming gases, which will be injected into the combustion chambers of the engine.

A second subject of the invention is a first preferred embodiment of a method for using an energy recovery system according to the invention, and the main technical feature of which is that it comprises the following steps:
blocking, by the first valve, of the first nozzle, so that at least a portion of the exhaust gases flows into the second nozzle to be cooled in the second compartment,
opening of the second valve to allow the cooled exhaust gases to be injected into the intake circuit of the engine.

This is usage of recirculation type, for which cooled exhaust gases are routed into the intake circuit in order to influence the combustion conditions in the combustion chambers of the engine. According to a preferred embodiment of a method according to the invention, the two steps are concomitant.

A third subject of the invention is a second preferred embodiment of a method for using an energy recovery system according to the invention, and the main technical feature of which is that it comprises the following steps:
blocking, by the first valve, of the exhaust circuit between the points of connection of the two nozzles to said circuit, forcing all the exhaust gases to flow into the first nozzle,
closing of the second valve so that the gases pass through the second compartment before leaving the heat exchanger through the second nozzle then being discharged from the vehicle through an outlet of the exhaust circuit.

This is a usage of energy recovery type, for which the exhaust gases flow through a bypass loop, comprising the heat exchanger, before being discharged out of the vehicle. The hot exhaust gases are then used to heat a fluid circulating in said heat exchanger, and which can, for example, be the engine cooling water.

Advantageously, this second preferred embodiment of usage method according to the invention comprises at least one step of opening of the second valve in order to be able to route the hot exhaust gases, from the heat exchanger, into the intake circuit. In effect, the energy recovery step can be interspersed with at least one phase of recirculation of the hot exhaust gases consisting in routing them into the intake circuit. Thus, the second preferred embodiment of a usage method according to the invention can alternately incorporate energy recovery phases and hot exhaust gas recirculation phases. To switch from one category of phases to the other, it is sufficient to have the shutter of the second valve pivot between a closed position and an open position.

The energy recovery systems according to the invention offer the advantage of being able to be used according to three configurations, which are hot exhaust gas recirculation, cooled exhaust gas recirculation and energy recovery, by simplifying the operating mechanism of one of the two valves involved. Additionally, they have the advantage of improving the cold starting conditions of an engine, which is a phase that is always difficult to manage, because of a fairly slow rise in temperature of the engine.

A particularly advantageous application of the invention consists in combining the hot exhaust gas recirculation and energy recovery configurations.

Below is a detailed description of a preferred embodiment of an energy recovery system according to the invention, with reference to the single figure.

The single figure is a schematic view of the architecture of a heat engine involving a turbocharger and a bypass pipe of an energy recovery system according to the invention.

Referring to the single figure, a gas circuit of a heat engine 1 includes an intake circuit 2 situated upstream of said engine 1, and an exhaust circuit 3 situated downstream thereof. The intake circuit 2 schematically comprises an air inlet 4, supplying air to a compressor 5 via an inlet nozzle 6, the supercharged air from said compressor 5 being routed to the combustion chambers 7 of said engine 1, via a supply pipe 8. More specifically, this supply pipe 8 emerges in an intake distributor making it possible to distribute the air in to each of the combustion chambers 7 of the engine. This air is essential to ensuring good combustion conditions in said chambers 7. The exhaust gases, which have been burnt in the chambers 7, are discharged by means of an exhaust distributor and will supply a turbine 9, which is coupled to the compressor 5. The gases at the turbine outlet 9 will first flow into an exhaust gas recirculation system 10, comprising a catalyst, a NOx trap and a particulate filter, before being routed, either directly to an outlet 11 of the exhaust circuit 3, or to a bypass pipe 12 comprising a heat exchanger 13. The exhaust circuit 3 comprises all the elements and link pipes installed between the exhaust distributor and the outlet 11. The bypass pipe 12 has two inlet nozzles 14, 15, installed in parallel in the exhaust circuit 3, a first nozzle 14 emerging in a first flow compartment 16 of the exchanger 13, and a second nozzle 15 emerging in a second compartment 17 of the exchanger 13 in which a fluid circulates, said compartments 16, 17 being connected with one another. The first compartment 16 simply constitutes a passage for the exhaust gases, whereas the second compartment 17 makes it possible to cool the exhaust gases. In effect, a fluid, which can for example be cooling water for the engine 1, circulates in the second compartment and the hot exhaust gases arriving in said compartment 17 will be brought into contact with said fluid. The result of this is a heat exchange, which will have a tendency to lower the initial temperature of the gases, and to increase the initial temperature of the fluid. The first nozzle 14 is installed on the exhaust circuit 3 upstream of the second nozzle 15. A first valve 18, provided with a shutter 19 that can move in rotation, is installed in the exhaust circuit 3 to control the flow of the exhaust gases in to the two inlet nozzles 14, 15 of the bypass pipe 12, and to the outlet 11 of said circuit 3. This first valve can occupy only two positions: a first position for which the shutter 19 blocks the first nozzle 14 but allows the exhaust gases to flow to the second nozzle 15 or to the outlet 11 of the exhaust circuit 3, and a second position, represented by a broken line, for which the shutter 19 blocks the exhaust circuit 3 between the two points of installation of the two nozzles 14, 15 on said circuit 3. In this second position, the shutter 19 forces all the exhaust gases to flow through the first nozzle 14. The second position of the shutter 19 is deduced from the first position, by a theoretical rotation by a value of between 70° and 90°. In the present example, the value is 90°. In reality, this theoretical rotation should be considered with a tolerance of approximately 5°. The shutter 19 of this first valve 18 is suitable for being controlled to occupy at least one intermediate position situated between the first and the second positions. A second valve 20 is installed in the bypass pipe 12, at the outlet of the heat exchanger 13, to create a possible passage, for the exhaust gases from said heat exchanger 13, to be able to reach the intake circuit 2 and be mixed with the incoming gases. This second valve 20, which has a point of installation on the intake circuit 2, comprises a shutter 21 that can move in rotation between a fully open position, for which it allows the passage of the exhaust gases from the heat exchanger 13, in order to route them into the intake circuit 2, and a closed position for which it keeps the exhaust gases in the heat exchanger 13. The shutter 21 of this second valve 20 is suitable for being controlled to occupy at least one intermediate position situated between the fully open position and the closed position. This second valve 20 can optionally comprise a second shutter 22 that can move in rotation, and that is suitable for controlling the flow rate of the incoming gases into the intake circuit 2, upstream of the point of connection of said second valve 20 to the intake circuit 2 allowing the exhaust gases leaving the heat exchanger 13 to enter said intake circuit 2. This second shutter 22 is also suitable for occupying any intermediate position between a fully open position and a closed position. The second valve 20 provided with its two shutters 21, 22 can then be likened to a choke.

An energy recovery system according to the invention typically comprises the first valve 18, the second valve 20 and the bypass pipe 12 provided with its two inlet nozzles 14, 15 and its heat exchanger 13.

An energy recovery system according to the invention can be used according to three methods.

A first method comprises the following steps:
Blocking, by the first valve 18, of the first nozzle 14, so that at least a portion of the exhaust gases flows into the second nozzle 15 to be cooled in the second compartment 17,
opening of the shutter 21 of the second valve 20 to allow the cooled exhaust gases to be routed into the intake circuit 2 of the engine.

This first method corresponds to the implementation of a cooled exhaust gas recirculation.

A second method comprises the following steps:
blocking, by the first valve 18, of the exhaust circuit 3 between the points of connection of the two nozzles 14, 15 to said circuit 3, forcing all the exhaust gases to flow through the first nozzle 14,
closing of the shutter 21 of the second valve 20 so that the gases pass through the second compartment 17 after having flowed through the first compartment 16, and before leaving the heat exchanger 13 through the second nozzle 15, then being discharged out of the vehicle through the outlet 11 of the exhaust circuit 3.

A third method includes the two steps of the second method, and comprises at least one step of opening the second valve 20 in order to be able to route the hot exhaust gases, from the heat exchanger 13, into the intake circuit 2. For this method, the shutter 21 of the second valve 20 alternately undergoes at least one opening phase and at least one closing phase, to allow the coupling of a hot exhaust gas recirculation with an energy recovery, for which the hot exhaust gases will heat a fluid.

1. A system for recovering energy from a gas exhaust circuit of a heat engine, comprising:
an exhaust gas bypass pipe provided with a heat exchanger having a first flow compartment and a second compartment for cooling the gases, said compartments being connected, said pipe having two inlet nozzles installed in parallel on the exhaust circuit;
a first nozzle emerging in the first compartment; and
a second nozzle emerging in the second compartment, the first nozzle being installed on the exhaust circuit upstream of the second nozzle,
said system comprising:
a first valve installed in the exhaust circuit and suitable for controlling the flow of the gases in each of said nozzles;
and a second valve for controlling the flow of the gases at the outlet of the heat exchanger,
wherein the first valve has only two positions, a first position for which it blocks the first nozzle and allows the flow of the exhaust gases in the second nozzle and to the outlet of said circuit, and a second position for which it blocks the exhaust circuit between the points of connection of the two nozzles to said circuit and allows the flow of the exhaust gases only in the first nozzle.

2. The energy recovery system as claimed in claim 1, wherein the first valve has a shutter that can move in rotation, and wherein the shutter performs a rotation by a value of between 70° and 90° to switch from the first position to the second position.

3. The energy recovery system as claimed in claim 1, wherein the exhaust circuit has a gas recirculation system comprising a particulate filter, and wherein the first valve is installed in the exhaust circuit downstream of said recirculation system.

4. The energy recovery system as claimed in claim 1, wherein the second valve is connected to the intake circuit, and is for routing the exhaust gases from the heat exchanger into said intake circuit.

5. The energy recovery system as claimed in claim 4, wherein in that the second valve comprises a shutter that can move in rotation and is for pivoting between a closed position for which it blocks the gases in the exchanger, and an open position for which it allows the flow of the gases to the intake circuit.

6. The energy recovery system as claimed in claim 5, wherein the shutter performs a rotation by a value of between 70° and 90° to switch from the open position to the closed position, and wherein said shutter is suitable for being fixed in at least one intermediate position situated between these two positions.

7. The energy recovery system as claimed in claim 5, wherein the second valve comprises a second shutter controlling the flow rate of the gases in the intake circuit, upstream of the point of connection of said second valve to the intake circuit.

8. A method for using an energy recovery system as claimed in claim 1, comprising:
blocking, by the first valve, of the first nozzle, so that at least a portion of the exhaust gases flows into the second nozzle to be cooled in the second compartment; and
opening of the second valve to allow the cooled exhaust gases to be routed into the intake circuit of the engine.

9. A method for using an energy recovery system as claimed in claim 1, comprising:
blocking, by the first valve, of the exhaust circuit between the points of connection of the two nozzles to said circuit, forcing all the exhaust gases to flow through the first nozzle; and
closing of the second valve so that the gases pass through the second compartment after having flowed into the first compartment before leaving the heat exchanger through the second nozzle then being discharged from the vehicle through an outlet of the exhaust circuit.

10. The method as claimed in claim 9, further comprising at least one step of opening of the second valve in order to be able to route the hot exhaust gases, from the heat exchanger, into the intake circuit.
